(19) United States
(12) Patent Application Publication
(10) Pub. No.: US 2016/0093880 A1
(43) Pub. Date: Mar. 31, 2016

(54) METHOD FOR MANUFACTURING ELECTRODE AND ELECTRODE MANUFACTURED BY THE SAME

(71) Applicant: LG CHEM, LTD., Seoul (KR)

(72) Inventors: Jin-Oh SONG, Daejeon (KR); Yong-Joon CHOI, Daejeon (KR); Won-Chan PARK, Daejeon (KR); Kyoung-Ho KIM, Daejeon (KR)

(21) Appl. No.: 14/865,397

(22) Filed: Sep. 25, 2015

(30) Foreign Application Priority Data
Sep. 29, 2014 (KR) 10-2014-0130522
Sep. 21, 2015 (KR) 10-2015-0132911

(51) Int. Cl. H01M 4/36; F26B 3/28; H01M 4/62

(52) U.S. Cl. CPC H01M 4/366; H01M 4/622; F26B 3/28

(57) ABSTRACT

Disclosed is a method for manufacturing an electrode, which comprises drying an electrode sheet including a current collector and an electrode active material slurry coated to the current collector and containing an electrode active material, a binder and a solvent, wherein the electrode sheet is dried by a mid-infrared lamp which irradiates mid-infrared rays with a wavelength of 1 μm to 3 μm to the electrode sheet, and a surface temperature of the electrode sheet has a constant region in the range of 50° C. to 70° C. Since an electrode is dried by using a mid-infrared lamp, the electrode may be uniformly dried, and an adhesion force between the electrode active material layer and the current collector may be greatly improved, which allows great enhancement of characteristics of a battery to which the electrode is applied.

### BACKGROUND OF THE DISCLOSURE

1. Field of the Disclosure

The present disclosure relates to a method for manufacturing an electrode and an electrode manufactured by the method, and more particularly, to a method for manufacturing an electrode, which irradiates mid-infrared rays while drying an electrode sheet having a current collector coated with an electrode active material slurry, to improve an adhesion force between the current collector and the electrode active material layer, and an electrode manufactured by the method.

This application claims priority to Korean Patent Application No. 10-2014-0130522 filed in the Republic of Korea on Sep. 29, 2014 and Korean Patent Application No. 10-2015-0132911 filed in the Republic of Korea on Sep. 21, 2015, the disclosures of which are incorporated herein by reference.

2. Description of the Related Art

A recent important trend in the development of electronic industries may be summed up as tendency for wireless or mobile devices and shifting from analog to digital. Rapid propagation of wireless phones (or, cellular phones) and notebook computers and shifting from analog cameras to digital cameras may be representative examples.

Along with the above tendency, secondary batteries serving as a power source of a device are being actively studied and developed. Among them, a lithium secondary battery using a lithium transition metal oxide, a lithium composite oxides or the like as a positive electrode active material and having high output and great capacity in comparison to weight is highly favored. Generally, a lithium secondary battery is configured so that an electrode assembly having a positive electrode, a separator and a negative electrode is included in a sealed container together with an electrolyte.

Meanwhile, the lithium secondary battery includes a positive electrode, a negative electrode, a separator interposed between the positive and negative electrodes, and an electrolyte, and is classified into a lithium ion battery (LIB), a lithium polymer ion battery (PLIB) or the like depending on which kind of material is used as a positive electrode active material and a negative electrode active material. Generally, the electrode of the lithium secondary battery is prepared by coating a current collector having a copper sheet, mesh, film or foil form with a positive or negative electrode active material and then drying the same. At this time, if the electrode is prepared to have a low adhesion force between the electrode active material layer and the current collector, the electrode active material layer and the current collector may be separated during a post-process, which may cause defects.

Meanwhile, in order to dry the electrode, convention drying using a hot air in a drying oven is frequently, and if a drying condition (air temperature, volume or the like of the hot air) varies, the drying rate and the adhesion force between the electrode active material layer and the current collector are also changed. This also has a relation with the structure such as residual moisture, residual solvent and binder distribution in the electrode active material layer. Generally, a high adhesion force is exhibited at a slow drying rate, but for mass production of the electrode, the drying condition should be controlled (increase of temperature and air volume) in order to ensure a drying rate over a certain level, which however may deteriorate the adhesion force. In addition, if a slow drying rate is applied, the adhesion force may be decreased due to local non-dried regions.

When an electrode is dried using an existing convection drying method, if the same material is used, the adhesion force between the electrode active material layer and the current collector is restrictive. Therefore, it is demanded to apply a new drying process in order to improve the adhesion force and optimize the process window such as surface temperature of the electrode, binder distribution, drying rate variation or the like.

### SUMMARY OF THE DISCLOSURE

The present disclosure is designed to solve the problems of the related art, and therefore the present disclosure is directed to providing a method for manufacturing an electrode with a greatly improved adhesion force between an electrode active material layer and a current collector in comparison to an existing technique, and an electrode manufactured by the method.

In one aspect of the present disclosure, there is provided a method for manufacturing an electrode, which comprises drying an electrode sheet including a current collector and an electrode active material slurry coated to the current collector and containing an electrode active material, a binder and a solvent, wherein the electrode sheet is dried by a mid-infrared lamp which irradiates mid-infrared rays with a wavelength of 1 μm to 3 μm to the electrode sheet, and a surface temperature of the electrode sheet has a constant region in the range of 50° C. to 70° C.

At this time, an adhesion force between the electrode active material layer and the current collector generated by drying the electrode active material slurry is 20 gf/cm to 30 gf/cm.

In addition, the electrode sheet may be dried for 50 seconds to 125 seconds.

Moreover, the constant region may have a duration time of 20 seconds to 100 seconds.

Meanwhile, the output of the mid-infrared lamp may be controlled to adjust the surface temperature of electrode sheet and a duration time of the constant region in the constant region.

In addition, the mid-infrared rays may have a wavelength at which the solvent has a maximum mid-infrared absorption rate.

Meanwhile, the solvent may be selected from the group consisting of water, acetone, dimethyl acetamide, dimethyl formaldehyde, and mixtures thereof.

In another aspect of the present disclosure, there is also provided an electrode, manufactured by the above method according to the present disclosure.

According to the embodiment of the present disclosure, since an electrode is dried by using a mid-infrared lamp, the electrode may be uniformly dried, and an adhesion force between the electrode active material layer and the current collector may be greatly improved, which allows great enhancement of characteristics of a battery to which the electrode is applied.

### BRIEF DESCRIPTION OF THE DRAWINGS

The accompanying drawings illustrate preferred embodiments of the present disclosure and, together with the foregoing disclosure, serve to provide further understanding of the technical features of the present disclosure. However, the present disclosure is not to be construed as being limited to the drawings.

FIG. 1 is a graph showing a surface temperature of an electrode sheet, measured during hot air drying according to a comparative example of the present disclosure.

FIG. 2 is a graph showing a surface temperature of an electrode sheet, measured during mid-infrared drying according to an embodiment of the present disclosure.

FIG. 3 is a graph showing an adhesion force between an active material layer and a current collector of an electrode, manufactured according to the result of hot air drying according to the comparative example of the present disclosure.

FIG. 4 is a graph showing an adhesion force between an active material layer and a current collector of an electrode, manufactured according to the result of mid-infrared drying according to the embodiment of the present disclosure.

FIG. 5 is a graph showing a constant drying finish time and an adhesion force between the active material layer and the current collector of the electrode, respectively manufactured according to the drying results according to the comparative example and the embodiment of the present disclosure, together.

FIG. 6 is a graph comparatively showing binder contents at the interface of the active material layer and the current collector of the electrodes, respectively manufactured according to the drying results of the comparative example and the embodiment of the present disclosure.

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

A method for manufacturing an electrode according to the present disclosure includes a step of drying an electrode sheet including a current collector and an electrode active material slurry coated to the current collector and containing an electrode active material, a binder and a solvent. Here, the electrode sheet is dried by a mid-infrared lamp which irradiates mid-infrared rays with a wavelength of 1 μm to 3 μm to the electrode sheet, and a surface temperature of the electrode sheet has a constant region in the range of 50° C. to 70° C.

According to the present disclosure, the electrode is dried by using a mid-infrared lamp which irradiates mid-infrared rays with a wavelength of 1 μm to 3 μm. At this time, the mid-infrared lamp may not irradiate light in ultraviolet and visible bands. The mid-infrared penetrates the electrode active material layer in a thickness and directly collides with residual solvent and residual moisture present in the electrode active material layer to instantly evaporate the solvent or moisture. Therefore, since evaporation occurs simultaneously at the surface and inside of the electrode, an adhesion force between the binder and the current collector is enhanced, and eventually the battery may have improved performance.

At this time, the constant region means a region where the surface temperature of the electrode sheet varies within a range of 5° C. according to a drying time of the electrode sheet. In the present disclosure, the constant region of the surface temperature of the electrode sheet is formed in 50° C. to 70° C., which is higher as much as 20° C. to 30° C. in comparison to the existing case of hot air drying.

In the present disclosure, since the constant region is formed at a relatively higher temperature, the binder is dispersed more easily. For this reason, the binder may be more uniformly distributed in the thickness direction of the electrode, or the content of the binder at the interface between the electrode active material layer and the current collector interface relatively increases in comparison to the binder content at the surface of the electrode active material layer, which may further improve the adhesion force between the electrode active material layer and the current collector.

Meanwhile, if the constant region of the surface temperature of the electrode sheet has a temperature lower than 50° C., residual moisture may be generated, and the solvent may not be easily removed, which may cause non-dried areas at the electrode. In addition, the drying time becomes prolonged, which deteriorates productivity. If the temperature of the constant region is higher than 70° C., defects may be more easily caused at the electrode due to excessive drying.

In addition, the constant region may have a duration time of 20 seconds to 100 seconds. Here, if the constant region has a duration time within the above range, residual solvent and residual moisture present at the surface of the electrode active material layer may be rapidly removed, and the temperature of the electrode active material layer may rapidly increase. At this time, the drying process should be stopped in order to prevent firing. Here, residual solvent and residual moisture present in the electrode active material layer may not be suitably removed, which may deteriorate the adhesion force between the electrode active material layer and the current collector.

Meanwhile, if the constant region has a longer duration time, the adhesion force between the electrode active material layer and the current collector is greater. This is because the possibility of internal re-diffusion and stress relaxation of the binder and the electrode active material increases as the constant region of the binder and the electrode active material has a longer duration time. However, if the constant region has an excessively long duration time, non-dried areas may occur at the electrode and productivity of the electrode may deteriorate. For this reason, the duration time is preferably adjusted not to exceed 100 seconds.

The duration time of the constant region may be controlled by adjusting an output of the mid-infrared lamp. Here, the output of the mid-infrared lamp (Lamp) means an electric output of the mid-infrared lamp, namely an electric output of a lamp with a wavelength of 1 μm to 3 μm. Here, 100% output represents 1 kW/Lamp.

According to the present disclosure, if the mid-infrared lamp has a greater output, the constant region has a shorter duration time, and the adhesion force between the electrode active material layer and the current collector tends to decrease. In the present disclosure, the output of the mid-infrared lamp is preferably adjusted to the range of 55% to 80%.

At this time, the adhesion force between the electrode active material layer and the current collector, generated by drying the electrode active material slurry may be 20 gf/cm to 30 gf/cm. This is about two or four times in comparison to the case where slurry of the same material is dried using an existing convection drying method.

At this time, since the drying process is performed for 50 seconds to 125 seconds, the adhesion force is improved while consuming a smaller time in comparison to an existing drying method using convection.

Meanwhile, by adjusting an output of the mid-infrared lamp, it is possible to control the surface temperature of the electrode sheet in the constant region and the duration time of the constant region. According to the present disclosure, if the mid-infrared lamp has an increased output, the surface temperature of the electrode sheet in the constant region tends to rise, but the duration time of the constant region tends to decrease.

In addition, the mid-infrared rays may have a wavelength at which the solvent has a maximum mid-infrared absorption rate.

The solvent may use water as an inorganic solvent and may also use acetone, dimethyl acetamide, dimethyl formaldehyde or the like as an organic solvent.

Meanwhile, according to another embodiment of the present disclosure, there is provided an electrode manufactured according to the above method of the present disclosure. In the electrode of the present disclosure, as described above, a binder is uniformly distributed in the electrode active material layer in a thickness direction, and the content of the binder at the interface between the electrode active material layer and the current collector interface is relatively greater than the binder content at the surface of the electrode active material layer, which may further improve the adhesion force between the electrode active material layer. For this reason, the adhesion force between the electrode active material layer and the current collector is about two to four times in comparison to an electrode manufactured using an existing hot air drying method.

### 1. Preparation of an Electrode Sheet

A mixture including 90 parts by weight of LiMnO₂ serving as a positive electrode active material in a solid powder form, 5 parts by weight of SBR serving as a binder and 5 parts by weight of CMC serving as a viscosity agent was mixed with a NMP solvent to prepare a positive electrode active material slurry. At this time, the content of NMP was adjusted to be 50 weight % on the basis of the positive electrode active material slurry.

After that, the positive electrode active material slurry was coated on a copper current collector to make an electrode sheet before drying.

### 2. Comparative Example

### Hot Air Drying of the Electrode Sheet

The prepared electrode sheet was put into a hot air drying machine to dry the electrode sheet. At this time, the electrode sheet was dried while varying the temperature of the hot air supplied into the drying machine. During the drying process, a surface temperature of the electrode sheet was measured at intervals of 3 seconds to 12 seconds by using an infrared rays thermometer attached to an inside of the drying machine, and a region where the surface temperature is not different over 5° C. during the drying process was set as a constant region.

### 3. Embodiment

### Mid-Infrared Drying of the Electrode Sheet

The prepared electrode sheet was put into a drying machine at which mid-infrared lamps operate, to dry the electrode sheet. At this time, the mid-infrared lamps are located successively above the surface of the electrode sheet along an advancing direction of the sample.

Output of each lamp may be adjusted with a range of 0 kW to 1 kW (0% to 100%). In this embodiment, the electrode sheet was dried while varying the output of the lamp. Also, during the drying process, a surface temperature of the electrode sheet was measured at intervals of 3 seconds to 12 seconds by using an infrared rays thermometer attached to an inside of the drying machine, and a region where the surface temperature is not different over 5° C. during the drying process was set as a constant region. At this time, the output of the lamp was adjusted to be 55% to 80% in advance so that the constant region has a temperature of 50° C. to 70° C.

### 4. Measurement Result of Surface Temperature of the Electrode Sheet

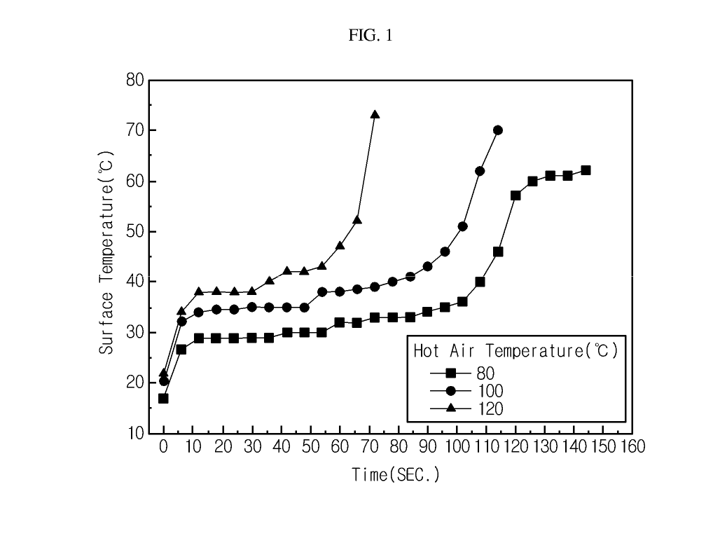

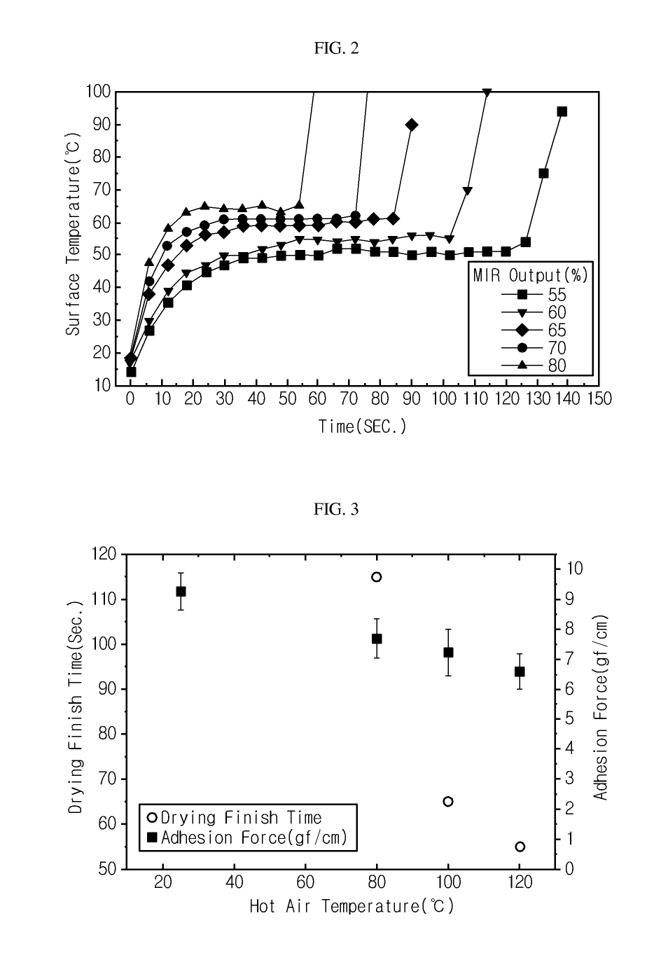

FIGS. 1 and 2 are graphs showing surface temperature of electrode sheets according to the comparative example and the embodiment, measured during the drying process.

Referring to FIGS. 1 and 2, it may be found that in the comparative example, the constant region of the surface temperature of the electrode sheet was measured to have temperature of 20° C. to 45° C., but in the embodiment, the constant region was measured to be 50° C. to 70° C.

In addition, referring to FIG. 1, it may be found that if the hot air has higher temperature, the constant region of the surface temperature of the electrode sheet is measured to be higher, but the duration time of the constant region decreases.

For this reason, referring to FIG. 2, it may be found that if the output of the infrared lamp increases, the constant region of the surface temperature of the electrode sheet is measured to be higher, but the duration time of the constant region decreases.

### 5. Measurement Result of an Adhesion Force Between the Electrode Active Material Layer and the Current Collector

The adhesion force between the active material layer and the current collector of the electrodes, respectively manufactured according to the drying methods of the comparative example and the embodiment was measured (Peel Off Test).

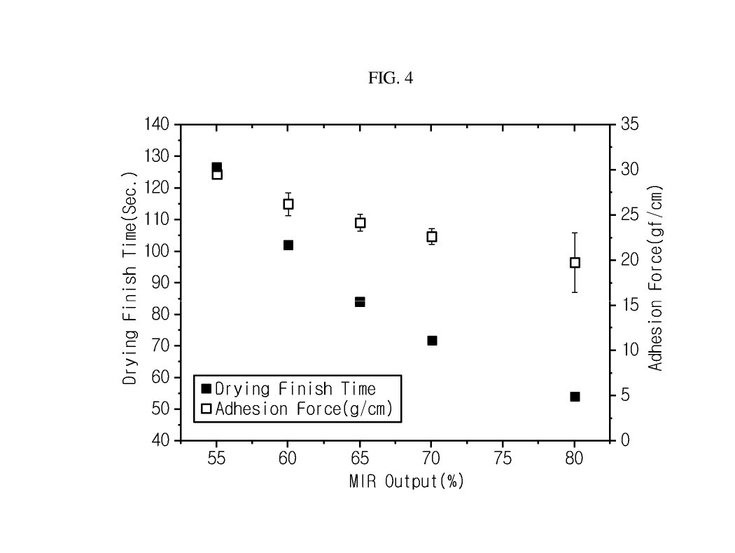

FIGS. 3 and 4 are graphs respectively showing the adhesion force between the active material layer and the current collector of the electrodes manufactured according to the drying methods of the comparative example and the embodiment.

Referring to FIGS. 3 and 4, it may be found that the electrode manufactured according to the comparative example exhibits an adhesion force of 6 gf/cm to 10 gf/cm, but the electrode manufactured according to the embodiment exhibits an adhesion force of 20 gf/cm to 30 gf/cm, which is two to four times stronger than the adhesion force of the comparative example.

In addition, in the comparative example and the embodiment, if the constant region has a shorter duration time, the adhesion force tends to decrease, and this tendency is also identical in the mid-infrared drying. However, it may be found that when comparing the duration time of the same constant region, the mid-infrared drying exhibits twice or more adhesion force in comparison to the hot air drying.

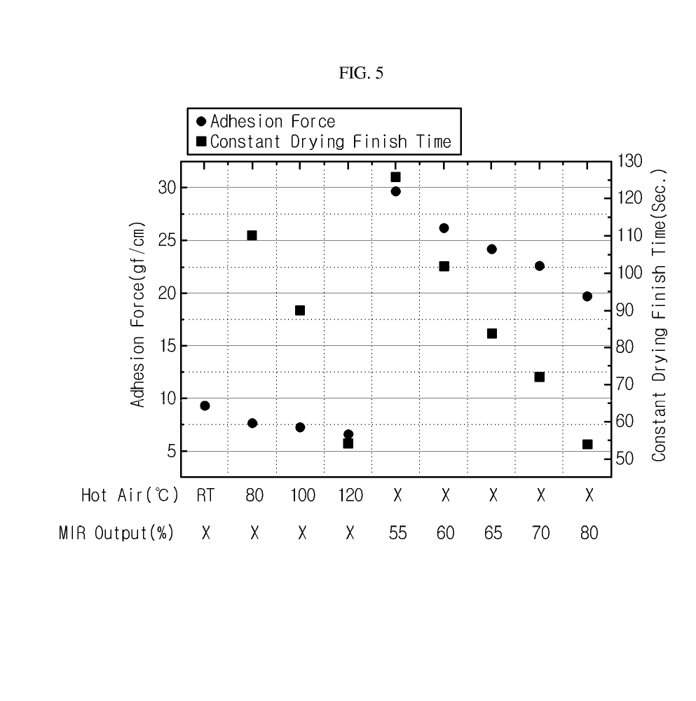

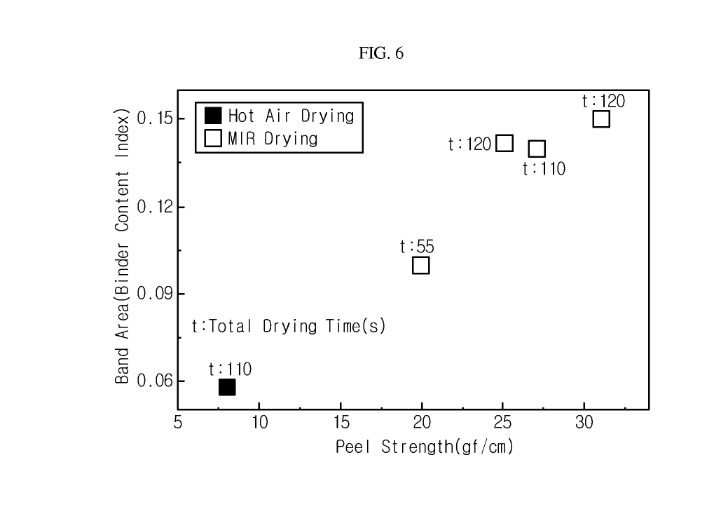

Meanwhile, FIG. 5 is a graph showing a constant drying finish time and an adhesion force between the active material layer and the current collector of the electrodes, respectively manufactured according to the drying results according to the comparative example and the embodiment of the present disclosure, together. Referring to FIG. 5, even though the same mid-infrared heat source is used, if the output increases, the surface temperature of the electrode sheet in the constant region increases, but since drying is performed relatively faster, the viscosity of the binder increases, which suppresses diffusion of the binder inside the electrode. Thus, in this case, it may be found that that the adhesion force between the current collector and the active material layer decreases.

According to the above result, if the mid-infrared drying is used, the adhesion force between the current collector and the active material layer increases due to higher electrode surface temperature and improved diffusion of the binder into the electrode, in comparison to hot air drying. In addition, by adjusting the output of the mid-infrared lamp, the duration time of the constant region may be changed, and the duration time of the constant region and the adhesion force are exhibited proportional to each other.

### 6. FTIR Analysis Result of a Binder Content for the Electrode Active Material Layer

In order to check a binder content in the active material layer in electrodes, respectively manufactured by applying mid-infrared drying and hot air drying, FTIR analysis was performed to the electrode active material layer. The analysis result is shown in Table 1 below.

TABLE 1

| | SBR binder Band Area A (1730/cm) | | | |
|---|---|---|---|---|
| | Surface of | active material layer | | adhesion |
| | the active | and current collector | | force |
| Condition | material layer | interface | A_{bot}/Aₜₒₚ | (gf/cm) |
| hot air | 0.072 | 0.058 | 0.81 | 8 |
| drying | | | | |
| MIR | 0.052 | 0.096 | 1.85 | 23 |
| drying | | | | |

Referring to Table 1, when the mid-infrared drying is used, it may be found that a content of the binder present at a bottom of the active material layer, namely at an interface between the active material layer and the current collector electrode, is measured to be greatly higher than a content of the binder present at a surface of the active material layer, and as a result, an adhesion force is also greatly higher at the bottom. Meanwhile, when the hot air drying is performed, it may be found that the binder relatively moves to the surface of the active material layer.

In addition, FIG. 6 is a graph comparatively showing binder contents at the interface of the active material layer and the current collector of the electrodes, respectively manufactured according to the drying results of the comparative example and the embodiment of the present disclosure. Referring to FIG. 6, it may be found that in case of the MIR drying of the present disclosure, even though the drying time is similar or rather shorter, the binder content at the interface between the active material layer and the current collector is higher, and accordingly the adhesion force at the interface is greatly increased, in comparison to the hot air drying.

The foregoing disclosure is only provided to illustrate the technical aspects of the present disclosure, and it will become apparent to those skilled in the art that various changes and modifications may be made without departing from the essential features of the present disclosure. Accordingly, it should be understood that the embodiments disclosed herein are intended to describe the technical aspects of the present disclosure, not to limit the scope of the present disclosure. The scope of protection of the present disclosure shall be defined by the claims, and all technical aspects equivalent thereto shall be construed as falling within the scope of protection of the present disclosure.

1. A method for manufacturing an electrode, which comprises drying an electrode sheet including a current collector and an electrode active material slurry coated to the current collector and containing an electrode active material, a binder and a solvent,
wherein the electrode sheet is dried by a mid-infrared lamp which irradiates mid-infrared rays with a wavelength of 1 μm to 3 μm to the electrode sheet, and a surface temperature of the electrode sheet has a constant region in the range of 50° C. to 70° C.

2. The method for manufacturing an electrode according to claim 1,
wherein an adhesion force between the electrode active material layer and the current collector generated by drying the electrode active material slurry is 20 gf/cm to 30 gf/cm.

3. The method for manufacturing an electrode according to claim 1,
wherein the electrode sheet is dried for 50 seconds to 125 seconds.

4. The method for manufacturing an electrode according to claim 1,
wherein the constant region has a duration time of 20 seconds to 100 seconds.

5. The method for manufacturing an electrode according to claim 1,
wherein the output of the mid-infrared lamp is controlled to adjust the surface temperature of electrode sheet in the constant region.

6. The method for manufacturing an electrode according to claim 1,
wherein the output of the mid-infrared lamp is controlled to adjust a duration time of the constant region.

7. The method for manufacturing an electrode according to claim 1,
wherein the mid-infrared rays have a wavelength at which the solvent has a maximum mid-infrared absorption rate.

8. The method for manufacturing an electrode according to claim 1,
wherein the solvent is selected from the group consisting of water, acetone, dimethyl acetamide, dimethyl formaldehyde, and mixtures thereof.

9. An electrode, manufactured by the method defined in claim 1.
